(19) United States
(12) Patent Application Publication
(10) Pub. No.: US 2004/0044749 A1
(43) Pub. Date: Mar. 4, 2004

(54) Method and system for controlling class of service admission to a server

(76) Inventor: Arthur S. Harkin, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/231,031

(22) Filed: Aug. 30, 2002

(51) Int. Cl. G06F 15/16

(52) U.S. Cl. 709/219

(57) ABSTRACT

A method and system are disclosed for controlling admission to a server. In accordance with exemplary embodiments of the present invention, a request is received from a requester for a session on the server at a first time for a first class of service. In response to the request, a capacity assessment of the server for servicing the request at the first time for the first class and for a second class of service different from the first class is determined. The requestor is offered an option to gain access to the server at the first time for the second class.

### CROSS-REFERENCE TO RELATED APPLICATION

This application is related to commonly owned, co-pending U.S. patent application Ser. No. ______ Attorney Docket No. 10010451, entitled “Method And System For Controlling Admission To A Server Using Temporary Server Access,” which is being concurrently filed herewith, the entire contents of which are hereby incorporated by reference herein.

### BACKGROUND

1. Field of the Invention

The present invention relates generally to network management, and more particularly, to controlling admission to a server.

2. Background Information

Protocols exist in which one computer (e.g., a “host”) receives and processes messages from a number of other computers (“clients”). For example, the host can be a server that receives and processes concurrent messages from different clients represented as personal computer users.

One or more related messages can be used to designate a session. For example, a multiple-message session can include a message requesting information over the World Wide Web, and an associated response. Alternatively, a multiple-message session can, for example, include a commercial transaction, with related messages being used to locate a web site for a precise product; to submit an order or billing and shipping information; and to convey a confirmation of sale to a particular client.

The term “quality of service” refers to a host's ability to provide a response to a message and to complete a session. For example, due to heavy traffic, a host may not be able to respond to a message at all, or the host may not provide a timely response (which can cause a client to “time-out” and generate an error).

One approach to controlling admission to a server is disclosed in U.S. Pat. No. 6,006,269, entitled “Admission Control System with Messages Admitted or Deferred for Re-submission at a Later Time on a Priority Basis,” to Peter Phaal, the entire disclosure of which is hereby incorporated by reference herein. Exemplary embodiments of the '269 patent are directed to using measurement-based admission control to determine whether a requested web site is available to process a new session. According to an exemplary embodiment, if the site is not available, based upon current resources and defined load parameters, the server-based system determines when the associated server can later provide preferred access to the client, and transmits to the client an indication of that time, together with a key.

Another approach is disclosed in U.S. Pat. No. 6,055,564, entitled “Admission Control Where Priority Indicator is Used to Discriminate Between Messages,” to Peter Phaal, the entire disclosure of which is hereby incorporated by reference herein. Exemplary embodiments of the '564 patent are directed to admission control systems with multiple classes of service and priority processing. In an exemplary embodiment, an admission control system for a given server admits incoming messages which are part of a session in progress. As to messages representing new sessions, the admission control system admits such messages on the basis of a priority or class assigned to them, or otherwise discriminates between messages stored in a message queue based on priority. For example, two different messages may be assigned different status if they are associated with two web sites resident on the server having different levels of available service; as server resources become stretched, the message associated with one of the web sites will receive better quality of service than a message associated with the second web site. For deferred messages, the exemplary admission control system determines when priority access can later be provided to a particular client requesting access to one of the web sites, and transmits to the client an indication of that time.

### SUMMARY OF THE INVENTION

A method and system are disclosed for controlling class of service admission to a server. In accordance with exemplary embodiments of the present invention, a request is received from a requestor for a session on the server at a first time for a first class of service. In response to the request, a capacity assessment of the server for servicing the request received at the first time for the first class, and for a second class of service different from the first class, is determined. The requestor is offered an option to gain access to the server at the first time for the second class.

In accordance with an alternate exemplary embodiment of the present invention, a system for controlling admission to a server comprises means for determining, in response to a request by a requester for a session on the server at a first class of service, a capacity assessment of the server for servicing the request received for the first class and for a second class of service different from the first class, and means for offering the requestor an option to gain access to the server at the second class.

In accordance with an alternate exemplary embodiment of the present invention, a computer program product comprises a computer readable medium embodying executable instructions thereon for causing a computer system to control admission to a server. In response to a request by a requestor for a session on the server at a first time for a first class of service, a capacity assessment of the server for servicing the request at the first time for the first class, and for a second class of service different from the first class is determined. The requester is offered an option to gain access to the server at the first time for the second class.

### BRIEF DESCRIPTION OF THE DRAWINGS

Other objects and advantages of the present invention will become apparent to those skilled in the art upon reading the following detailed description of exemplary embodiments, in conjunction with the accompanying drawings, wherein like reference numerals have been used to designate like elements, and wherein:

FIG. 1 is a flowchart illustrating exemplary steps for controlling admission to a server; and

FIG. 2 is a block diagram illustrating an exemplary system for controlling admission to a server.

### DETAILED DESCRIPTION OF THE EXEMPLARY EMBODIMENTS

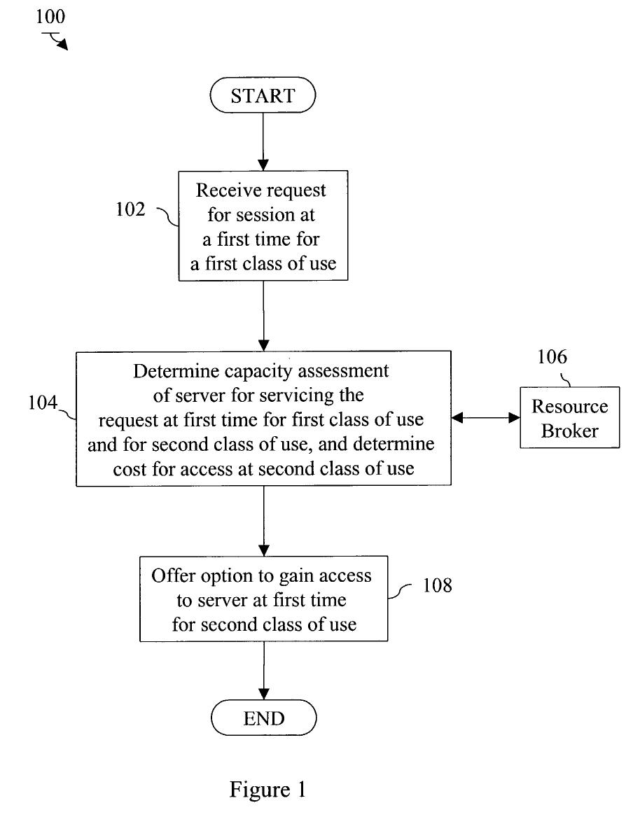

FIG. 1 is a flowchart 100 illustrating steps to be carried out for controlling admission to a server based on class of service according to an exemplary embodiment of the present invention. After starting, in step 102 of FIG. 1, a request is received for a session on the server at a first time for a first class of service (that is, a first class of access and/or use). As referenced herein, the “first time” can be any desired time period, including, but not limited to, a period of time within which the server receives a request and performs sufficient processing on the request to make a decision to grant or deny any access to the server, for any class of service, in response to the request. The “first class of service” can be any designation attributed to the request as a function of any desired attribute (e.g., time associated with processing the request), the first class of service being a level of access and/or use corresponding, for example, to an anticipated processing associated with the requestor at any time before, during or after the time the request is received.

In step 104 a capacity assessment of the server is determined for servicing the request received at the first time for the first class and for a second class of service. A cost can be determined for access to the server at the second class of use. In this context, a “second class of service” can be a designation which would afford the requestor a different level of service from the level of service afforded to users at the first class of use. For example, the second class can be a “premium” class of service defined, for example, as a class which possesses an increased payment, or for which a limited number of services are offered, or by any other desired criteria. As another example, the second class can be a “downgraded” class of service defined, for example, as having fewer services, or a lower class of service than the first class. If the second class is a “downgrade” from the first class, then it may not be necessary to compute a cost to be assessed to the requestor, as the server may not require as many resources to process a request for the second class as would be required for a request of the first class. The second class can also simply offer services which are different from the first class.

In an exemplary embodiment, the system can optionally be configured to support users at multiple classes of service. Different classes of service can be allocated in any desired manner. For example, requesters can select among different fees for different levels of use and accessibility. The fee structure can be configured to, for example, support premium access for a single message, a single session, for a predetermined period of time, and/or for a period of time delimited by events defined by the requestor meeting agreed terms of premium access (e.g., as long as the required premium access fee is paid and the requester meets all terms of the access offer).

The premium access fee can, for example, be encoded in the identification of the requester to the server, and can be used to give the requestor a queued access to the server on a first-in first-out basis with respect to any other requesters of the premium class. The premium class can, for example, be limited in number to ensure a high probability of immediate servicing. For example, the premium class can be limited to a static number, or can be dynamically limited using a predictive queuing model using any desired policies. Suitable predictive queuing models include, without limitation, those described in “Performance Evaluation And Stress Testing For E-Commerce Systems”, by J. Rolia et al, Abstract for CASCON '98 Demonstration (1998), hereby incorporated by reference in its entirety. Of course, any structure can be used including, but not limited to, the use of attributes other than payment of fees to establish different levels of use.

The capacity assessment can be performed by any software, hardware and/or firmware mechanism. In an exemplary embodiment, capacity assessment can be performed by accessing a resource broker 106, to which the server can be coupled either directly (e.g., a resource broker internal to the server) or indirectly (e.g., over a network connection including any wired or wireless connection). A “resource broker” is a hardware, software and/or firmware entity (e.g., a resource broker system) which can determine whether additional resources are available to the server, or whether additional resources can be provisioned to offer the requestor of the session an immediate change in class of service (e.g., an upgraded, downgraded or alternate similar service level). The resource broker 106 can be configured to provide information on current use of server resources. The resource broker 106 can, for example, be configured as a resource monitor discussed in the '269 patent, or in any other suitable manner to achieve the functionality described herein. The resource broker can also be configured to monitor trends based on statistical analysis of archived use information, for predicting future use. The resource broker can function in accord with any desired allocation and scheduling policies, and these policies can be static and/or can be dynamically updated. By way of example, and without limitation, resource brokers which can be used are those which are based on a predictive queuing model with associated policies, as well as those available from Mantra (e.g., IRX at www.mantranet.com), Peakstone (e.g., at www.peakstone.com) and others.

In an exemplary embodiment, the system monitors the resources of the server to determine whether the resources are utilized at least to a predetermined threshold percentage of the capacity of the resources (e.g., 80% utilization, or any desired threshold which can be a fixed or adaptive threshold). The system can, for example, determine that no more requesters at the first class of service will be given access to the server at the first time unless they accept an option to upgrade to a higher priority class (e.g., a “premium” level of use). The system can monitor the resources to determine whether the resources become utilized to a more strained level (e.g., 90% utilization), and determine that no more requestors will be given access to the server at the first time, as the level of service may become significantly degraded for all requestors of access. At this point, future requesters can be given deferred access, in a manner as disclosed in the '269 patent, until it is determined that a particular criterion has been met, such as the percentage, or measurement, of utilization of the resources has decreased, or otherwise changed, to an acceptable level to permit access to more requestors. Alternatively, decisions regarding capacity of the resources can be made by using tables and/or other measurement techniques and/or any user specified inputs.

In step 108, an option to gain access to the server at the first time for the second class is offered, for example, to the requestor of the access. The option can include, for example, an option to gain access at the second class for a current transaction and for requests for future sessions, an option to gain access at the second class for a current transaction, an option to gain access at the second class for a duration of the session, and/or an option to gain access at the second class for a period of time determined by the capacity assessment. Thus, the option can include an offer to modify the level of access for an indefinite period of time, such as a “permanent” change.

The second class can offer different access and/or use to the requestor through a policy designation which is attributed to the second class. For example, the second class can have an associated policy to acquire additional resources to assure a desired responsiveness for the second class.

As another example, the option can include an offer of a “downgraded” class of service defined, for example, as having fewer services, or a lower class of service than the first class. Alternatively, the option can include an offer of services which are different from services included in the first class. The option can include an offer of deferral as discussed in the '269 patent. An exemplary option can take the form of an information page downloaded to the requestor or any other suitable form.

In processing messages sent for the server, an admission system can be configured to determine whether a particular message is part of a session in progress or is a new request. To track transactions, the system can, for example, maintain and update a transaction list of requests which includes, for example, information on the requesters and sessions. For example, a list of identifications associated with the requesters (that is, actual identifiers of the requestors and/or indirect indicators thereof) can be maintained. The system can maintain an identification of the requester in the form of an identifier provided to the requester for tracking requests (e.g., a data structure, such as a cookie, written to the requester) or any other suitable form including, but not limited to, the types of maintenance of tracking information discussed in the '269 patent.

A requested class of use can, in an exemplary embodiment, be either stored or derivable from an indicator within a requestor's message, and can be persistent for the duration of the session. A class of use indicator can be explicitly stored as a name value pair in a data structure, such as a cookie that is initially generated by a server and stored on the client for future access by the same or other servers. The cookie can be used to keep state through the client across multiple HTTP requests. A cookie can, for example, include an expiration date, a domain and a path that specifies which servers can receive the cookie from the client. Within the cookie's name=value field, the class of use can be encoded explicitly, or other information (e.g., user or session identification) can be encoded which can be used to derive the class of use. Class of use indicators can alternately include, but are not limited to, encoded URLs, XML tags, and so forth.

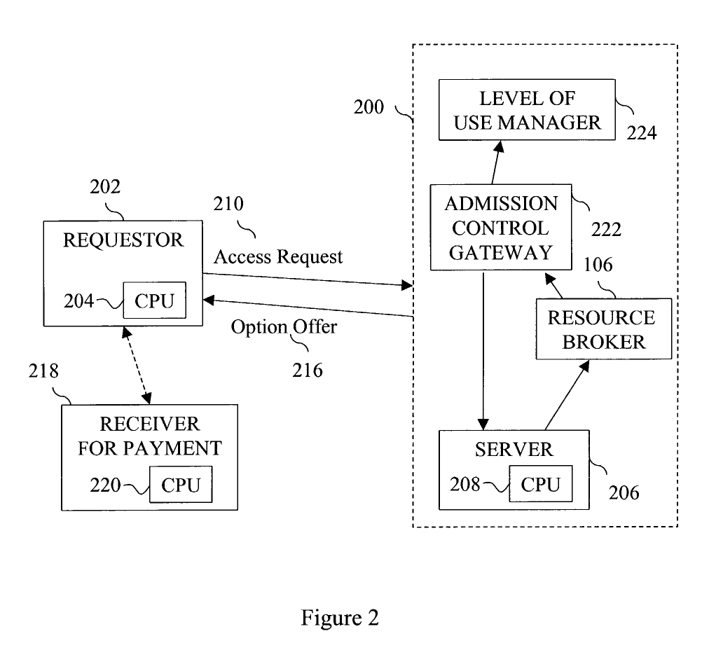

FIG. 2 is a block diagram illustrating an exemplary admission control system 200 for controlling admission to a server 206. A requestor 202, which includes any suitable CPU 204, generates an access request 210 for a first class of service, which is received by the admission control system 200. In response to the request, an admission control gateway 222 accesses a means for determining a capacity assessment of the server for servicing the request received for the first class, and for a second class of service different from the first class. For example, the resource broker 106 can be provided to determine a capacity assessment of server 206. A level of use manager 224 uses the information regarding the capacity of the server for servicing at least two different classes of service (e.g., the requested class and an available class) to generate an option offer 216 to the requester. The server 206 can include a CPU 208, to then service the access request 210.

According to an exemplary embodiment, the server 206 interfaces with the resource broker 106 and the level of use manager 224 to assess the current load on the resources of the server 206, and determines whether the server 206 has a capability to accept the access request 210 by comparing the available resources of the server with the resources required to service the request. All serviceable requests to the server can be ordered based on a cost assigned as a function of the maximum possible resource-load they may involve. When the server is incapable of immediately accepting a request, a price can be determined as a function of the cost and/or an alternate level of service (e.g., next available service class) having a different cost can be identified.

For example, the resource broker 106 can be configured to optionally determine a price (e.g., via access to a look-up table of relative prices associated with different classes of service) to be assessed to the requester 202 for access to the server 206 at the first class or at a different class of service than the initial, or first, class of service associated with the requester 202 at the time of the access request 210. Alternatively, or in addition to offering an ability to service a given request, an offer can be made to service a request having a different (e.g., lesser or greater) cost. For example, the requester 202 can be offered a modified list of available services which, if accepted, can be used to afford the requester 202 immediate access (e.g., a lower priority class of use), and/or the requester can be offered a modified price which, if paid, would afford the requestor immediate access to all requested services.

The level of use manager 224 can be configured as a computer (e.g., dedicated computer or integrated in a computer used to implement the resource broker, the admission control gateway and/or the server), and generates an option offer 216 which is transmitted to the requestor 202. In this sense, the level of use manager can merely translate the information it receives from the resource broker into a stored message correlated via a look-up table to the circumstances identified by the resource broker. For example, the option offer 216 can be a stored message which informs the requestor 202 that the server 206 is currently experiencing heavy traffic to a degree that the server 206 will not admit the requester 202 at the requested first class of use, but the requester 202 can gain access to the server 206 at a second class of use (e.g., a higher, lower or otherwise different priority class of use) to gain immediate access.

As an example, the level of use manager 224 can be a policy-based manager that implements a set of business logic rules that interprets the current and/or projected resource utilization from the resource broker 106, the requestor's 202 current class of use, and then directs what alternative classes of use can be negotiated via an option offer 216 with the requestor 202 by the admission control gateway 222. The acceptance or non-acceptance of the option offer 216 by the requestor 202 can be used to determine the enforcement taken by the admission control gateway 222 on the access request 210. When the admission control gateway receives an access request and the capacity assessment by class by the resource broker, the admission control gateway can invoke the level of use manager 224 with a procedural call.

An exemplary logic flow of a level of use manager 224 can include, without limitation, the following steps:

1. Values for the following variables may be included as part of the call invocation of the level of use-manager:

a. REQUESTOR_CLASS (of type CLASS_OF_USE)

b. SYSTEM_UTILIZATION

c. CURRENT_UTILIZATION[CLASS_OF_USE]

d. RATE OF_ARRIVAL [CLASS_OF_USE]

e. RATE OF_PROCESSING [CLASS_OF_USE]

f. TREND_RATE_OF_ARRIVAL[CLASS_OF_USE]—-projected rate of arrival; the resource broker can be configured to provide a trend analysis on the near future projection of capacity needs of requests of a class. Such projections can use class-based information including average request arrival rates, past time-based arrival rates, average capacity utilized by a request, and current total capacity utilized by requests of this class.

2. Evaluate business logic rules to assess class of services that can be serviced. The business logic rules can be evaluated in priority order. Further evaluation then stops after locating the first business logic rule that evaluates as true; the lowest priority business rule can be a default rule and evaluates as true.

3. Process the business logic rule that was evaluated as true to determine:

a. What class options are to be offered

b. The offer message, if needed

4. Return to the admission control gateway the values for the following variables:

a. CLASS_OPTIONS [CLASS_OF_USE, ACTION]

b. OPTION_OFFER_MESSAGE

When processing the business rules, a set of related static business information including, without limitation, values, procedures and formulas, is available and can include:

SLA_RATING[CLASS_OF_USE]={GUARANTEED, BEST_EFFORT}

TARGET_THRESHOLD[CLASS_OF_USE]=utilization_value

SYSTEM_THRESHOLD=utilization value

AVAILABLE_GUARANTEED_CLASSES( )=find and return a list of guaranteed classes with available headroom (TARGET_THRESHOLD[RC]−CURRENT_UTILIZATION[RC]) that is ordered by headroom size.

In the foregoing example, the SLA Rating is a service level agreement rating. Pricing and terms for each CLASS_OF_USE, in particular for GUARANTEED classes, can be used in the generation of an OPTION_OFFER_MESSAGE.

An exemplary set of business rules to complement a logic flow described herein can include the following, wherein RC is an alias for REQUESTOR_CLASS

RULE 1. if SLA_RATING[RC] is GUARANTEED and ((TREND_RATE OF_ARRIVAL[RC]>RATE_OF PROCESSING[RC]) or (CURRENT_UTILIZATION[RC]>TARGET_THRESHOLD[RC])) then

a. set CLASS_OPTIONS[class, action] to include:

i. RC, admit

ii. RC, defer

b. OPTION_OFFER_MESSAGE created to offer requester to continue in same class at normal charge, or to defer until a later time but with a rebate or no charge.

RULE 2. if SLA_RATING[RC] is BEST_EFFORT and (CURRENT_UTILIZATION[RC]>TARGET_THRESHOLD[RC]) then

a. find AVAILABLE_GUARANTEED_CLASSES( )

b. set CLASS_OPTIONS[class, action] to include

i. for each CLASS in AVAILABLE_GUARANTEED_CLASSES

1. CLASS, admit

ii. RC, reject

c. OPTION_OFFER_MESSAGE created to offer requestor the ability to upgrade to a higher available guaranteed class at that class's pricing and terms, or to otherwise have the access request be rejected.

RULE 3. if SYSTEM_UTILIZATION>SYSTEM_THRESHOLD then

a. if SLA_RATING[RC] is GUARANTEED then

i. set CLASS_OPTIONS[class, action] to include

1. RC, defer

b. if SLA_RATING[RC] is BEST_EFFORT then

i. Set CLASS_OPTIONS[class, action] to include

1. RC, reject

d. No OPTION_OFFER_MESSAGE is given

RULE 4. set CLASS_OPTIONS[class, action] to include

a. RC, admit

b. No OPTION_OFFER_MESSAGE is given

The admission control gateway can determine from a class option list that contains more than one class and action pair, that the OPTION_OFFER_MESSAGE should be sent prior to making an admission control decision (e.g., a decision on the actions: admit, defer, reject). If only one class and action pair exists in CLASS_OPTION, then the admission control gateway can treat the request at that class and take the assigned action.

When an an OPTION_OFFER_MESSAGE is given, the requestor can take actions from that message that would change their class if they accept the conditions (e.g. changes their class described in an HTTP cookie). The requestor then submits a new request. If the option is to keep the same class but accept a resulting action (such as ‘defer’) then the original request is made again with an indicator of this temporary action (e.g. an indicator can include this additional information that is described in an HTTP cookie).

An exemplary option offer 216 from the admission control system to the requester can include instructions for making a payment, or a reference address (such as a URL) directing the requestor 202 to a receiver 218 for payment. The receiver 218 can include a CPU 220, for receiving payment which affords the requester immediate access to the server 206. Alternatively, the admission control system 200 can include the receiver functionality for processing payments or other forms of exchange to effect an acceptance of the option offer 216.

The option offer 216 can take any desired form, including but not limited to, the form of an exemplary web page downloaded to the requester 202. An exemplary message for a downloaded web page is shown in Table I below:

TABLE I
Welcome to our server.
We are currently experiencing heavy traffic, but we can offer you
immediate access for this session at a premium level of service for
only $3.00 (U.S.), and we can offer a long-term upgrade to premium
service for only $20 (U.S.) per month. Instant payment may be
made by accessing www.xyz.com, and your premium access will be
granted immediately upon our receipt of their confirmation of your
payment.

As shown in Table I, if the server 206 is experiencing sufficient traffic (for example, traffic that would preclude the server 206 from admitting a requestor 202 who generates an access request 210), the admission control system 200 can respond to the request for access 210 by offering the requester 202 an option offer 216 to change (e.g., “upgrade”) to a different (e.g., higher) level of service, or class. For example, the admission control system 200 can inform the requester 202 of a cost for an “upgrade” and, for example, can provide the requestor 202 with information on how to pay the cost to obtain access to the server 206 at the different level of use. For example, any web site which accepts payments on behalf of various parties conducting electronic transactions on the Internet can be used. Of course, any manner deemed suitable to authorize a change in class of service can be used including, but not limited to, active or passive acquiescence by the requester.

In some cases, the system can be configured to require third party authentication of the requestor before granting a change in class of service. Alternately, where a requestor has an established account (e.g., the host regularly bills or debits the requestor's account), the requestor can be already authenticated to the host server. As such, acceptance of an option offer by the requester can be used by the host server to mark the session/transaction as in a different class of service (i.e., the class associated with the option offer) without additional third party authentication. The host server can, of course, be configured to alternately, or in addition, send a message for an optional third party authentication (e.g., a software accounting application), if desired.

If the requestor 202 does not accept the option offer 216, the admission control system 200 can reject the access request 210, or can, for example, give the requestor 202 a deferral as discussed in the '269 patent. Alternately, the admission control system can process at the first class of service, even though this may be less desirable in terms of quality of service provided. If the requester 202 does not respond to the option offer 216 within a predetermined period of time, or if the requestor 202 “times out” before responding to the option offer 216, the admission control system 200 can, for example, treat the non-responsiveness as a non-acceptance, and reject the access request 210, give the requester 202 a deferral as discussed in the '269 patent, or process at the first class of service. Alternatively, the admission control system 200 can re-evaluate the access request 210 by determining a capacity assessment of the server 206 for servicing the request after a period of non-responsiveness by the requestor 202, and can offer a second option offer 216 based on the second capacity assessment.

The requester 202 need not be limited to a single user on a single personal computer (PC), but can include without limitation a server, multiple users or clients on multiple computing devices such as desktop devices, portable devices, handheld devices (e.g., mobile telephones, pagers, personal digital assistants (PDAs)) and/or any other device which can request access to a server. The requester 202 can also include a software agent implemented in any form of software and/or hardware. For example, a client application can make a request to a host application (i.e., server) for service, and negotiate an option to upgrade/downgrade with a host application (i.e., server) via an application to application protocol such as XML.

The server 206 can include one or multiple servers servicing multiple users or clients, and can be configured as a server which includes an admission control gateway and deferral manager similar to the admission control gateway of the '269 patent, but including, for example, a level of use manager 224 which makes decisions regarding options for changing the level of use for various requestors 202 of access to the server 206.

The admission control system 200 can optionally determine whether a particular message is part of a session in progress or is a new request. To track transactions, the admission control gateway 222 can, for example, maintain and update a transaction list which includes information used to track the requesters 202 and sessions (e.g., in the form of a list of indicators of identifications associated with the requestors 202 or any other suitable form). The admission control system 200 can optionally maintain an identification of the requester 202 (e.g., in the form of a cookie written to the requester 202, or any other suitable form).

An admission control system can include capabilities as described in the commonly assigned, aforementioned U.S. application entitled “Method and System For Controlling Admission To A Server Using Temporary Server Access”, or in the aforementioned U.S. Pat. No. 6,006,269.

For example, where a requestor sends a message that does not have an indication to the class of use, current system resource utilization may be high enough to eliminate access for some classes, but allow a temporary access for this message until either its class of use can be determined or until a certain period of time passes, as described in the aforementioned application. Once the class of use has been determined, or a certain time has passed and a default class of use is assigned, the admission controller can determine whether an option to upgrade or downgrade the level service should be offered to the requestor. An upgrade might be offered when the current class of use of the requestor's message would cause it to be rejected or deferred, but it could be upgraded to a class of use that still has available capacity. A downgrade might be offered to a higher class of use request which is in a class of use that is on the edge of receiving poor performance, and the user is given an option to downgrade to a lower class (e.g. often delayed response) for a lower or no charge.

A computer program embodying the steps illustrated in FIG. 1 for controlling admission to a server can be embodied in any computer readable medium included in a computer program product for use by or in connection with an instruction execution system, apparatus, or device, such as a computer-based system, processor-containing system, or other system that can fetch the instructions from the instruction execution system, apparatus, or device and execute the instructions. As used herein, a “computer readable medium” can be any means that can contain, store, communicate, propagate, or transport the program for use by or in connection with the instruction execution system, apparatus, or device. The computer program product can be, but is not limited to, an electronic, magnetic, optical, electromagnetic, infrared, or semiconductor system, apparatus, device, or propagation medium or any other suitable medium. Specific examples of the computer program product, without limitation, can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A computer implemented method for controlling admission to a server comprising:
receiving from a requestor a request for a session on the server at a first time for a first class of service;
determining, in response to the request, a capacity assessment of the server for servicing the request received at the first time for the first class of service and for a second class of service different from the first class; and
offering the requester an option to gain access to the server at the first time for the second class.

2. The method of claim 1, wherein the step of determining the capacity assessment of the server comprises:
determining the capacity assessment of the server for the first class and for the second class based on information generated by a resource broker.

3. The method of claim 1, wherein the second class includes at least one of:
a higher priority of server access than the first class;
a lower priority of server access then the first class; and
a different priority of server access than the first class of use.

4. The method of claim 1, wherein determining the capacity assessment comprises:
determining a price to be assessed to the requester to gain access at the second class as a function of the capacity assessment.

5. The method of claim 4, wherein the option to gain access includes at least one of:
an option to gain access at the second class for a current transaction and for requests for future sessions;
an option to gain access at the second class for a current transaction;
an option to gain access at the second class for a duration of the session; and
an option to gain access at the second class for a period of time determined by the capacity assessment.

6. The method of claim 1, wherein offering the requester an option comprises:
transmitting to the requester option information including at least one option description.

7. The method of claim 6, wherein transmitting option information comprises:
formatting at least one information page and downloading the at least one information page to the requester.

8. The method of claim 6, wherein transmitting option information comprises:
updating a list of information used to track requesters and sessions.

9. The method of claim 1, comprising:
requesting a payment to gain access at the second class.

10. The method of claim 9, comprising:
providing to the requestor a reference address to a site for acceptance of the payment.

11. The method of claim 1, comprising:
providing an identifier to the requester for tracking requests from the requestor.

12. A system for controlling admission to a server comprising:
means for determining, in response to a request by a requester for a session on the server at a first class of service, a capacity assessment of the server for servicing the request received for the first class and for a second class of service different from the first class; and
means for offering the requester an option to gain access to the server at the second class.

13. The system of claim 12, wherein the means for determining the capacity assessment comprises:
means for determining a price to be assessed for access to the server at the second class.

14. The system of claim 12, wherein the means for offering comprises:
means for requesting a payment for access to the server at the second class.

15. The system of claim 13, wherein the means for requesting comprises:
means for providing to the requestor a reference address to a site for acceptance of the payment.

16. The system of claim 12, wherein the means for offering comprises:
means for providing, to the requester, an identification of the requestor.

17. A computer program product comprising a computer readable medium embodying executable instructions thereon for causing a computer system to control admission to a server by:
determining, in response to a request by a requestor for a session on the server at a first time for a first class of service, a capacity assessment of the server for servicing the request at the first time for the first class, and for a second class of service different from the first class; and
offering to the requester an option to gain access to the server at the first time for the second class.

18. The computer program product of claim 17, wherein determining the capacity assessment of the server comprises:
determining the capacity assessment of the server for the first class and for the second class based on information generated by a resource broker.

19. The computer program product of claim 17, wherein the second class includes at least one of:
a higher priority of server access than the first class;
a lower priority of server access then the first class; and
a different priority of server access than the first class.

20. The computer program product of claim 17, wherein determining the capacity assessment comprises:
determining a price to be assessed to the requester to gain access at the second class as a function of the capacity assessment.

21. The computer program product of claim 20, wherein the option to gain access includes at least one of:
an option to gain access at the second class for a current transaction and for requests for future sessions;
an option to gain access at the second class for a current transaction;
an option to gain access at the second class for a duration of the session; and
the option to gain access at the second class for a period of time determined by the capacity assessment.

22. The computer program product of claim 17, wherein offering the requester an option comprises:
transmitting to the requester option information including at least one option description.
